(19) United States
(12) Patent Application Publication
(10) Pub. No.: US 2004/0006623 A1
(43) Pub. Date: Jan. 8, 2004

(54) Service providing mechanism

(75) Inventors: Christophe Gourraud, Montreal (CA); Sorin Surdila, Laval (CA)

Correspondence Address: SANDRA BEAUCHESNE, Ericsson Canada Inc., Patent Department (LMC/IP), 8400 Decarie Blvd., Town Mount Royal, QC, H4P 2N2, CA

(73) Assignee: Telefonaktiebolaget L M Ericsson (publ)

(21) Appl. No.: 10/189,250

(22) Filed: Jul. 5, 2002

(51) Int. Cl. G06F 15/16

(52) U.S. Cl. 709/227

(57) ABSTRACT

The mechanism for providing services to a terminal user includes identifying at least one service to be offered to the terminal user. Each of the identified services are then linked to a corresponding Hyper Text Terminal Protocol Uniform Resource Identifier (HTTP URI). A list is built for all linked HTTP URIs, and the list is forwarded to the terminal user. The terminal receives the list in the form of an incoming message, the incoming message comprising the HTTP URIs corresponding to services being offered to the user. The terminal displays the HTTP URIs, and obtains the user's selection. Then, the terminal activates the HTTP URI corresponding to the user's selection.

### BACKGROUND OF THE INVENTION

1. Field of the Invention

The present invention relates to Third Generation (3G) network, and in particular to a mechanism for providing services in such a network.

2. Description of the Related Art

3G cellular networks aim at replacing the existing cellular networks known today. For making it appealing to users and operators, the cellular industry has had to think of an architecture that would be flexible enough to offer a wide variety of services, a large number of types of terminals, while allowing users to be reachable everywhere. 3G architecture is thus the convergence of mobility concepts used and known in existing cellular networks, with scalable and flexible computer networks.

Such convergence however results in certain dichotomies. The existing cellular networks are based on dedicated nodes, having an extensive knowledge of the rest of the network, and keeping a tight control on its users. In turn, the computer networks avoid the concept of dedicated nodes, do not require knowledge of the other surrounding networks, and do not keep control of their users.

To overcome these dichotomies, the cellular industry has had to be quite creative, and to focus on the strength of each networks, rather than on their weakness or their incompatibilities. Therefore, the cellular industry has developed an architecture where the radio aspects and the mobility of users is dealt with in a manner somehow similar but of course improved of the existing cellular networks, while the services and packet data exchange has been completely revamped and inspired by principles of computer networks.

Since the mobility issue is dealt with in a manner similar to existing cellular networks, and services are using the philosophy of decentralized computer networks, the merging of the two concepts is not done without problems. Moreover, the merging is even more difficult when the services simultaneously require the cooperation of the two parts of the network. It is thus important at this stage of the development of 3G networks to provide a mechanism that will efficiently and in a costly manner provide a multitude of services to users, thus rendering 3G networks even more appealing.

The present invention provides such a mechanism.

### SUMMARY OF THE INVENTION

In one aspect, the present invention is a mechanism for providing services to a terminal user. The mechanism comprises:

identifying at least one service to be offered to the terminal user;

linking each of the identified at least service to a corresponding Hyper Text Terminal Protocol Uniform Resource Identifier (HTTP URI);

building a list of all linked HTTP URIs; and

forwarding the list of linked HTTP URIs to the terminal user.

In another aspect, the present invention is a terminal for providing services to a user of the terminal. The terminal is capable of:

receiving an incoming message, the incoming message comprising at least one Hyper Text Terminal Protocol Uniform Resource Identifier (HTTP URI) corresponding to a service being offered to the user;

displaying the at least one HTTP URI to the user;

obtaining a selection from the user; and

activating the HTTP URI corresponding to the user's selection.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is an exemplary network and signal flow diagram of the mechanism of the present invention;

FIG. 2 is an exemplary flowchart diagram of a mechanism for providing of services according to one of the preferred embodiments of the invention in the context of a set-up of a call session;

FIG. 3 is an exemplary network and signal flow diagram illustrative of a network in which the present invention is implemented in accordance with one of the preferred embodiments of the invention;

FIG. 4 is an exemplary flowchart diagram of providing of a mechanism for providing services in the context of a set-up of a call session according to another preferred embodiment of the invention; and

FIG. 5 is an exemplary network and signal flow diagram in which the present invention is implemented, in accordance with another one of the preferred embodiments of the invention.

### DETAILED DESCRIPTION OF THE PREFERRED EMBODIMENTS

The innovative teachings of the present invention will be described with particular reference to numerous exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views, and the various elements depicted are not necessarily drawn to scale.

The present invention consists of a mechanism for providing services to terminal users. For doing so, a list of possible services is provided in the form of HTTP URIs to the terminal user. Upon selection of one of the HTTP URIs by the user of the terminal, a corresponding HTTP address is activated, therefore providing the selected service to the terminal user. The list of possible services may be specifically related to the active session or not. Additionally, the list of services may be provided either before call completion, during a call of after a call termination. Optionally, the invention may send the list on some or all of the terminals related to the user, by making use for example of presence information. According to the invention, the list is forwarded to the user of the terminal in an incoming message. The incoming message can consist of a Session Initiation Protocol (SIP) instant message, or for example of a message as defined by the Wireless Village Protocol. The following description will make use of the SIP instant message, but it should be understood that the invention is not limited thereto. By, for example, simply clicking on the desired HTTP URI, the user activates the service. The service may consist of an application to be run, or of a web page which provides additional options. The invention will be described hereinafter in more details, and in the context of various embodiments.

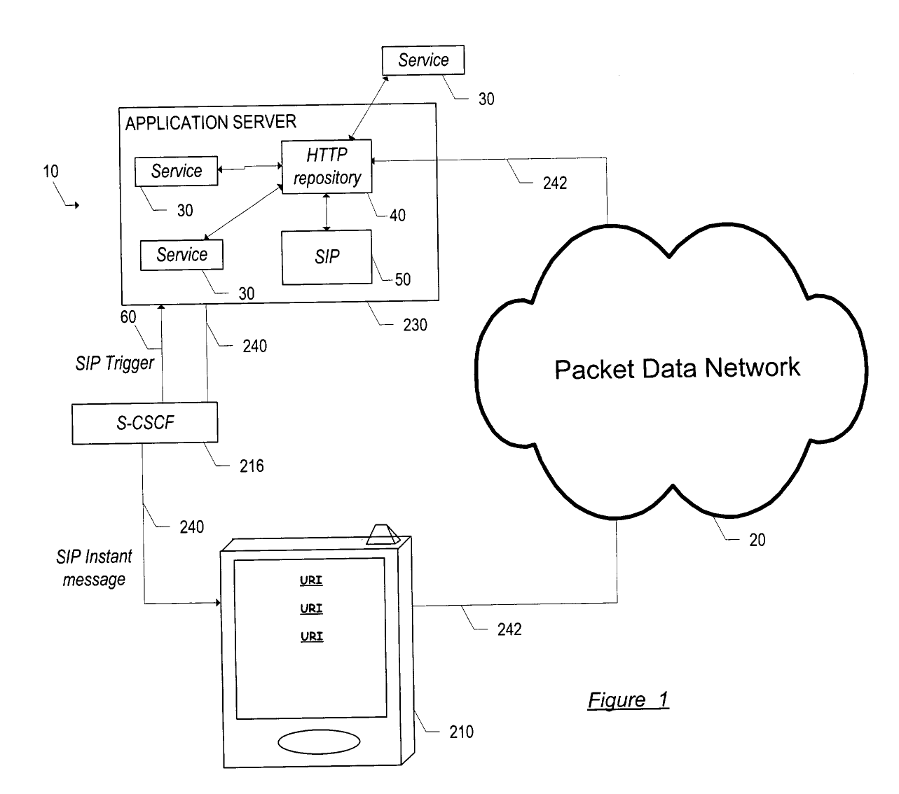

Referring now to FIG. 1, there is shown an exemplary network and signal flow diagram of the mechanism of the present invention. The network 10 is composed of an application server 230, a packet data network 20 and a serving Call Session Control Function (CSCF) 216. The invention is not limited to implementing the present mechanism into those nodes, and those nodes are used as references from a functional point of view, and not as strictly limited thereto. A terminal 210 communicates with the network 10. The terminal 210 is represented as a mobile station, but any other type of terminal capable of exchanging data could also be used: for example a Personal Computer, a Personal Digital Assistant, etc. The terminal 210 may also consist of a plurality of terminals (not shown), where each one of the terminals has its own identification address.

In the present invention, many services 30 are available either at the application server 230, or outside of the application server 230. The application server 230 also includes a web container 40, which links each of the services 30 to a corresponding Hyper Text Terminal Protocol Uniform Resource Identifier (HTTP URI). The HTTP URIs for the services are composed of a prefix that identifies an application, which provides the service, within the application server that, has generated that SIP Instant Message. In a preferable embodiment, the application server 230 is Java2 Enterprise Edition (J2EE) compliant.

Upon receipt of a trigger 60 at the application server 230, the application server 230 identifies at least one service to be offered to the terminal user. The service could be session-related, such as related to an incoming call, during a call, call termination, or any other non-session related service, such as messaging or presence-related, by other triggers received for the terminal or other nodes. Thus, the invention can be used in conjunction with any service supported by the network. Then, the application server 230 links each of the identified services to a corresponding HTTP URI. A list is then built using the linked HTTP URI and the list is forwarded to the terminal user. The list may consist of possible keywords describing services available to the terminal user, or simply of HTTP URIs inserted in text either provisioned by the network or by the user at an earlier time.

In the event that the received trigger 60 relates to an incoming call, the application server 230 identifies the services and forwards the list of possible call completion services to the terminal 210 prior to completing the call. If the received trigger 60 relates to an ongoing call, the identifying of the services and the forwarding of the list are performed by the application server during the call. And, in the event that the trigger 60 relates to call termination, the application server 230 performs the identifying, the building and the forwarding before terminating the call.

In addition, depending on the services 30 available, the application server 230 can identify services corresponding to terminal users being either called parties or caller. Of course, the services identified will probably differ in those two instances. Examples of services may consist, without being limited thereto, of: selective call forwarding, initiation of call conference, engaging call with third party, transfer to other terminal or selection of call type.

The terminal 210 receives the list of HTTP URIs forwarded by the application server 230 via the serving CSCF 216. In a preferred embodiment, the list of HTTP URIs is sent using a Session Initiation Protocol (SIP) Instant Message. The terminal 210 then displays the received list to the user. Upon selection by the user of one of the services, the selected HTTP URI is forwarded over the packet data network 20 to the application server 230, which activates the HTTP URI corresponding to the service selected by the user.

Prior to describing the preferred embodiments in detail, it is of importance to first provide a brief introduction of SIP. SIP is an Internet Engineering Task Force (IETF) standard protocol for initiating an interactive user session that may involve multimedia elements such as video, voice, chat, gaming, and virtual reality. Like the Hyper Text Terminal Protocol (HTTP), or the Simple Mail Transfer Protocol (STERMINALP), SIP works in the Application layer of the Open Systems Interconnection (OSI) communications model. SIP can establish multimedia sessions or Internet telephony calls, and modify, or terminate them. SIP invites participants to unicast or multicast communication sessions that do not necessarily involve the initiator. Because SIP supports name mapping and redirection services, it makes it possible for users to initiate and receive communications and services from any location, and for networks to identify the users wherever they are. SIP is a request-response protocol, dealing with requests from clients and responses from servers. Participants are usually identified by SIP Uniform Resource Identifiers (URIs), although SIP also supports E.164 telephone number addressing. Requests can be sent through any transport protocol, such as the User Datagram Protocol (UDP), the Simple Control Transport Protocol (SCTP), or the Transfer Control Protocol (TCP). SIP determines the end system to be used for the session, the communication media and media parameters, and the called party's desire to engage in the communication. Once these are assured, SIP establishes call parameters at either end of the communication, and handles call transfer and termination. SIP can also be used for handling communication sessions in Third Generation (3G) cellular telecommunications networks. SIP is specified in IETF Request for Comments (RFC) 2543, which is herein included by reference.

With the ever-growing use of diverse types of terminals, one given user may utilize on a regular basis more than one terminal. For example, professional John Doe may use i) a Personal Computer (PC) at home with permanent Internet access via a dedicated Internet access line, ii) a mobile station with wireless access to a cellular telecommunications network and to the Internet, a second PC at the office with Internet access via corporate Local Area Network (LAN), and a laptop computer for remote use at the clients' site, including a MODEM adaptor for use in connection with a mobile station for accessing the Internet. Typically, professional John Doe also has different identifiers (or addresses) for receiving communications on each one of these terminals, such as for example a phone number for the mobile station, and a SIP address for the personal computer. Therefore, it becomes difficult to efficiently reach John Doe, since a caller must know in advance John Doe's specific identifiers for each one of his terminals in order to be able to effectively contact him. The situation is further complicated when John Doe activates some of his terminals, while inactivating others. In such cases, it is sometimes impossible to reach the called party without first knowing all its identifiers, and without sequentially and manually attempting to reach each one of his terminals.

It is possible for a subscriber to establish a relation, preset in a CSCF, between his/her Public ID and one or more Contact IDs, which may be associated with a location or a terminal, and to activate a cascaded ringing feature in the serving CSCF. In such an implementation, when a call attempt is being made, the serving CSCF resolves the Contact IDs based on the received Public ID and on predetermined priority of terminals, and can either sequentially or in parallel ring each one of the associated terminals based on the priority. However, this enhanced prior art implementation is limited in terms of flexibility, since it requires pre-definition of the cascaded ringing, which is then applied in an unrestrictive manner for all subsequent call attempts, thus leaving no dynamic control to the subscriber.

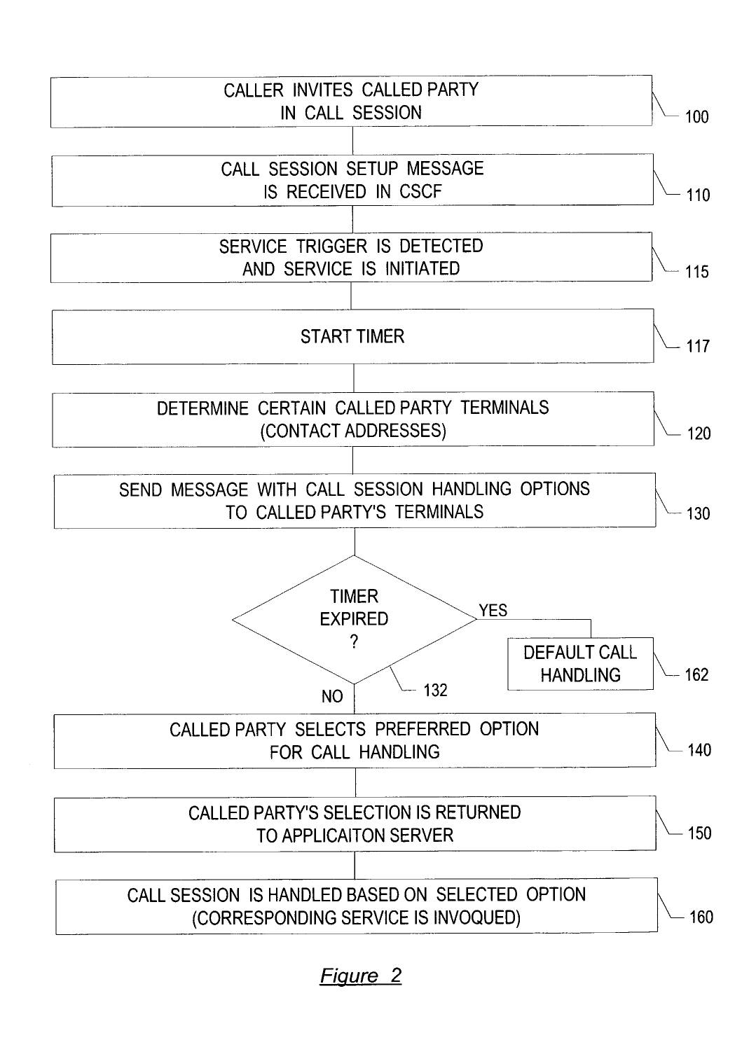

Referring now to FIG. 2, depicted therein is an exemplary flowchart diagram of a mechanism for providing of services according to one of the preferred embodiments of the invention in the context of a set-up of a call session. In that particular embodiment, the terminal user to which the services are provided is being called. The mechanism of the present invention thus provides the services to the called party prior to completing the call.

At step 100, a caller invites the called party into a communications session, such as for example into a SIP based communications session by issuing a communication set-up message, such as for example an SIP INVITE message comprising an identification of the called party. At step 110, the communication setup message reaches the serving CSCF of the called party. In step 115, it is detected a trigger condition for activating the providing of services to the called party. The trigger condition may comprise detecting a certain busy or other subscriber status, either directly provided by the network in the context of call setup, or as pre-defined by the subscriber. Alternatively, step 115 may be skipped when the default call processing that is setup in the CSCF includes the mechanism for providing services of the present invention. In step 117, a timer is started.

In step 120, it may be determined certain ones of the called party's terminals on which the communication session can be carried on. In a first variant of the invention, the CSCF may determine solely, or in combination with an application server, all the terminals of the called party, based on the called party's identification received into the communications setup message. In a second variant of the invention, the application server may determine solely, or in combination with a presence server, only the available terminals of the called party, i.e. all the terminals on which the user is indicated as being “present”, based on presence information related to the user and stored for example in the presence server.

Once the certain terminals of the called party are determined in step 120, in step 130 the application server transmits a message, to every one of the certain terminals for informing the called party of the incoming session that the caller attempts to establish and for giving the choice to the called party to select how the incoming session is to be handled. The instant message may have various forms and may preferably comprise an indication of the type of communication that the caller attempts to establish with the called party (e.g. a video communication session, a voice communication session, a file transfer communication session, a message and/or chat communication session, etc.) and a list of services that may be invoked for handling the incoming call session. The message sent to the terminals may comprise a list enumerating all the terminals determined in step 120, for example, in the form of HTTP URIs wherein one link corresponds to each terminal. Therefore, the instant message allows the called party to select where the communications session will be carried on by displaying a message that allows the called party to select by, for example, by clicking on a particular HTTP URI that corresponds to the terminal on which the user wants to carry on the session. The message may further or alternatively comprise an option for automatically declining the call session attempt, for no answer, for mail message transfer, etc. based on the identified services at the application server.

At step 140, the called party responds to the instant message on one given terminal by selecting one of the available services, which in this particular embodiment consist of options for call session handling. In step 150, the called party's selection is returned to the application server, and at step 160 the application server executes the service associated with the called party's selection. For example, if the called has selected to accept the communication on terminal B, the application server executes a service instructing the CSCF to redirect the incoming communication on the called party's terminal B.

Following the service trigger detection of step 115, the application server starts a timer, step 117, that helps in defining and monitoring a time period during which the application server awaits for the called party's input. Following the transmission of the message at step 130, the application server monitors for the selection of the called party. If the time does not expire, at step 132, the selection of the called party made at step 140 is accepted and the method continues as described hereinbefore. Otherwise, if at step 132 the timer expires and no selection is received before, the method continues with step 162 where the call attempt is treated according to the default implementation, such as for example by redirecting the call session to a mail message system that allows the caller to leave a message for the called party.

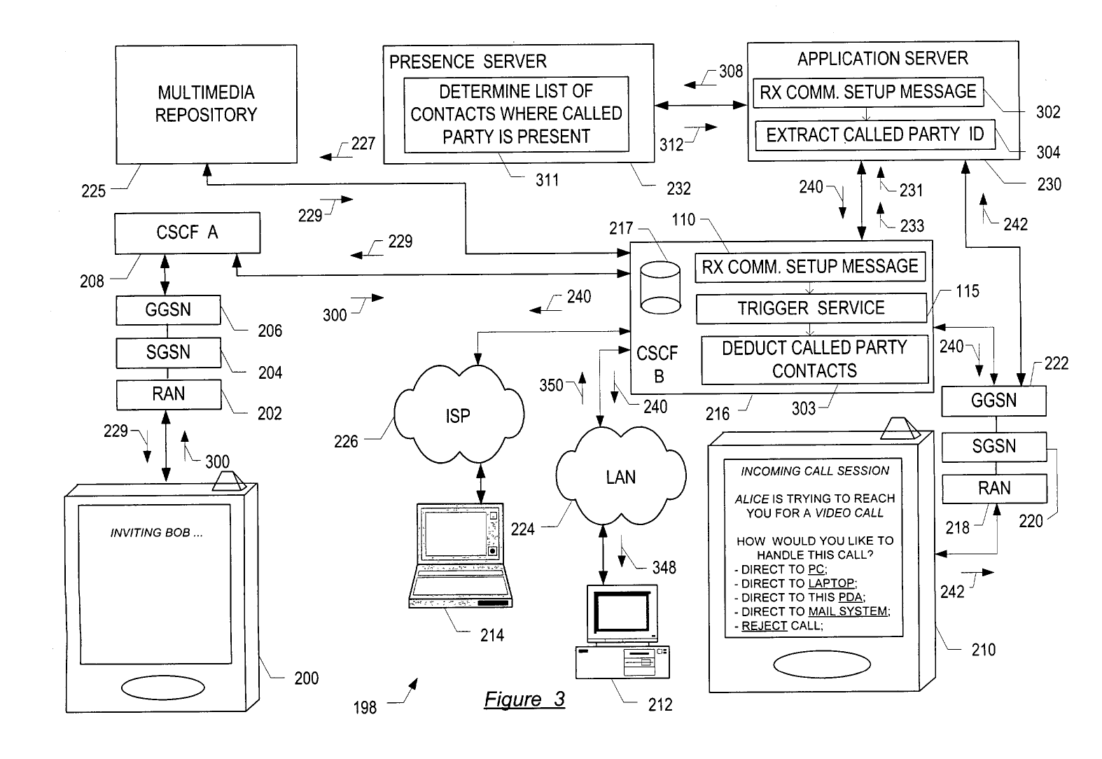

Reference is now made to FIG. 3, which is an exemplary network and signal flow diagram illustrative of a network in which the present invention is implemented in accordance with one of the preferred embodiments of the invention. A cellular telecommunications network 198 has a first mobile station (terminal) 200 receiving cellular services through a Radio Access Network (RAN) 202, a Serving GPRS Support Node (SGSN) 204, and a Gateway GPRS Support Node (GGSN) 206 in a manner which is well known in the art. The GGSN 206 further connects to a serving CSCF A 208. For purposes of the present scenario it is assumed that user Alice (A) uses terminal 200 in order to establish a new call session (also referred herein as a communication session) with the called party Bob (B), who has a first terminal 210, a second Personal Computer (PC) terminal 212, and a third laptop terminal 214. The terminal 210 connects to a serving CSCF B 216 via a RAN 218, an SGSN 220 and a GGSN 222 in a manner well known in the art. The personal computer terminal 212 connects to the CSCF B 216 via a Local Area Network (LAN) 224, while the laptop terminal 214 connects to the serving CSCF B 216 via an Internet Service Provider (ISP) 226. Furthermore, the CSCF A 208 connects to the CSCF B 216 via appropriate communication links, as it is known in the art.

For the present exemplary scenario, it is assumed that the caller Alice (A) uses the terminal A 200 in order to establish a new communication session, such as for example a video communication session with Bob. For this purpose, user Alice uses terminal 200 to issue a communication set-up message 300, such as for example an SIP INVITE message, intended for Bob. The message 300 comprises an identifier address for the recipient Bob, such as for example a Public Id that may be a SIP URI of the form “bob.name@niceprovider.com”, where “bob.name” identifies Bob and “niceprovider.com” identifies the network operator providing service to Bob. Message 300 is sent from the terminal A 200 via the RAN 202, the SGSN 204 and the GGSN 206 to the serving CSCF A 208, from where it is forwarded to the serving CSCF B 216 of Bob.

Upon receipt of the communication set-up message 300, action 110, the CSCF B 216 detects the trigger condition for activating the providing of services of the present invention, which in this specific embodiment relates to interactive inbound session handling services, action 115.

According to a first variant of the preferred embodiment of the invention, based on the identifier comprised in message 300 received in action 110, the CSCF B 216 determines the specific addresses of the called party Bob terminals, action 303. Of course, the CSCF B 216 may determine that it needs to perform this step, or it may be instructed to do so by the application server 230. For example, the CSCF B 216 may use a Contact Database 217 that stores, for each user registered with the CSCF, an association between its Public ID of a user and one or more Contact Ids identifying each terminal of the given user. With the information of the Contact Database 217, the CSCF B 216 may deduct from the Public Id “bob.name@niceprovider.com” a list of Contact Ids identifying terminals 210, 212, and 214, such as for example, bob.mobile@niceprovider.com for the terminal 210, bob.pc@niceprovider.com for the PC terminal 212, and bob.laptop@niceprovider.com for the laptop terminal 214. However, since this action may take longer in certain implementation, the CSCF may first request a multimedia repository 225, action 227, to send to the caller Alice (A) terminal 200 an intermediate message 229 informing of the status of the ongoing setup process. For example, message 229 may state:

“Hi Alice. I'm Bob's personal assistant. I need to look for Bob, so please given me a few seconds to look for him.”

At substantially the same time, the CSCF 216 communicates, action 231 with an Application Server 230 responsible for storing and executing various services, amongst others call processing services, in order to request the application server to issue a message for each one of the called party's Contact Ids.

The invention further proposes a second and preferred variant of the preferred embodiment of the invention. According to this variant, the CSCF B 216 is linked with the Application Server 230, to which it forwards the communication set-up message 300, action 233, once the service trigger is detected in step 115, for invoking the providing of services, which in this preferred embodiment relates to interactive inbound call session handling services. The application server 230 receives the message 300, action 233, and determines which ones of the terminals of the called party Bob are available, so that the message is only directed to these terminals. It should be understood that many terminals could be linked to a same address, if wanted by the user. Upon receipt of the message 233, action 302, the application server 302 identifies the Bob by extracting the identifier address (Public ID or SIP URI) of the message 300, action 304, and issues an interrogation message 308 for a Presence Server 232 that is responsible for storing presence status information along with other type of information related to communications subscribers, including that of subscriber Bob. The interrogation message 308 comprises the identifier address of the called party Bob extracted from message 233 (300), i.e. the Public Id or the SIP URI, and its purpose is to query for the terminals, also called herein contacts, where the called party Bob is marked as being present. In the preferred implementation of the invention, the interrogation message 308 is a standardized Subscribe message as defined, for example, in the Internet Engineering Task Force's (IETF) SIP for Instant Messaging and Presence Leveraging Extensions (SIMPLE) standard, herein included by reference.

Based on the presence information it stores, upon receipt of the message 308 with the identification of the called party Bob (ex: Public Id or SIP URI), the presence server 232 determines, action 311, a list of Contacts where the called party Bob is shown to be present, or alternatively, where the called party Bob is shown to be present for receiving a communication of a given type, such as for example the message to decline with announcement. In action 312 the presence server 232 also returns the contact list to the application server 232, for example in the form of an SIP Notify message. The contact list returned in message 312 may comprise, for example, the contact identity of all the three terminals of Bob, therefore showing that Bob is available at all his terminal. Thus, the contact list may comprise the SIP URIs identifying these three terminals, i.e. bob.mobile@niceprovider.com for the terminal 210, bob.pc@aniceprovider.com for the PC terminal 212, and bob.laptop@niceprovider.com for the laptop terminal 214.

Following action 303 of the first variant of the preferred embodiment of the invention, or action 312 of the second variant of the preferred embodiment of the invention, the application server 230 sends a message 240 to each one of the called party's terminals 210, 212, and 214 through the serving CSCF 216 for providing Bob with a series of options for handling the incoming call session in the communication session. In a particular case wherein only certain ones of the plurality of terminals of the called party Bob would have been determined to be available in actions 308-312, the instant messages is sent to these terminals.

The instant message 240 comprises a parameter identifying the type of the communication session, which in the present case is assumed to be a videoconference session, the list of contacts of the terminals as previously determined in the first or the second variant, and possibly other options for handling the call session. For example, the instant message 240 displayed on each terminal may read as follows:

“Incoming Call:

Alice is trying to contact you for a videoconference session.

How would you like to handle this call session:

direct to your personal computer terminal;

direct to your mobile station;

direct to your laptop terminal;

redirect to mail message system;

automatically decline;

press here to ignore this session.”

wherein each underline text of the message 240 is an HTTP URI associated with a service in the application server 230.

Called party Bob may respond from any one of the terminals that received the message 240 and select how the incoming session is to be handled. For example, Bob may answer from the terminal 210 that he would like to have the incoming video conference session being routed on his personal computer terminal 212 that has a larger screen and a more powerful processor better suited for handling video conference sessions.

In action 242, a response is returned from the terminal 210 to the application server 230 through the Packet Data Network (RAN 218, SGSN 220 and GGSN 222) with the called party's selection, following Bob's selection of a particular link. Upon receipt of the message 242, the application server 230 instructs the serving CSCF B 216 to direct the communication set-up message 300, or an equivalent or corresponding message 348, to the personal computer terminal 212. The called party Bob responds with an accept message 350, which triggers the actual establishment of the communications session between the caller Alice's terminal A 200 and the called party Bob's personal computer terminal 212.

In accordance with another embodiment of the present invention, the mechanism for providing services allows a caller, subscriber of an IP-based network, to instruct how to process an outgoing communication session. During the call session establishment, when a particular condition associated with the called party is detected, such as for example a busy status, the invention allows for sending a message to the caller on all his/her terminal, wherein the message contains a list of session processing options that may be pre-customized by the called party. By, for example, simply clicking on the desired option, the caller instructs the service how to process the current incoming session. For example, the caller can choose to forward or redirect the particular session to a new destination associated with the called party subscriber, or simply drop the call session.

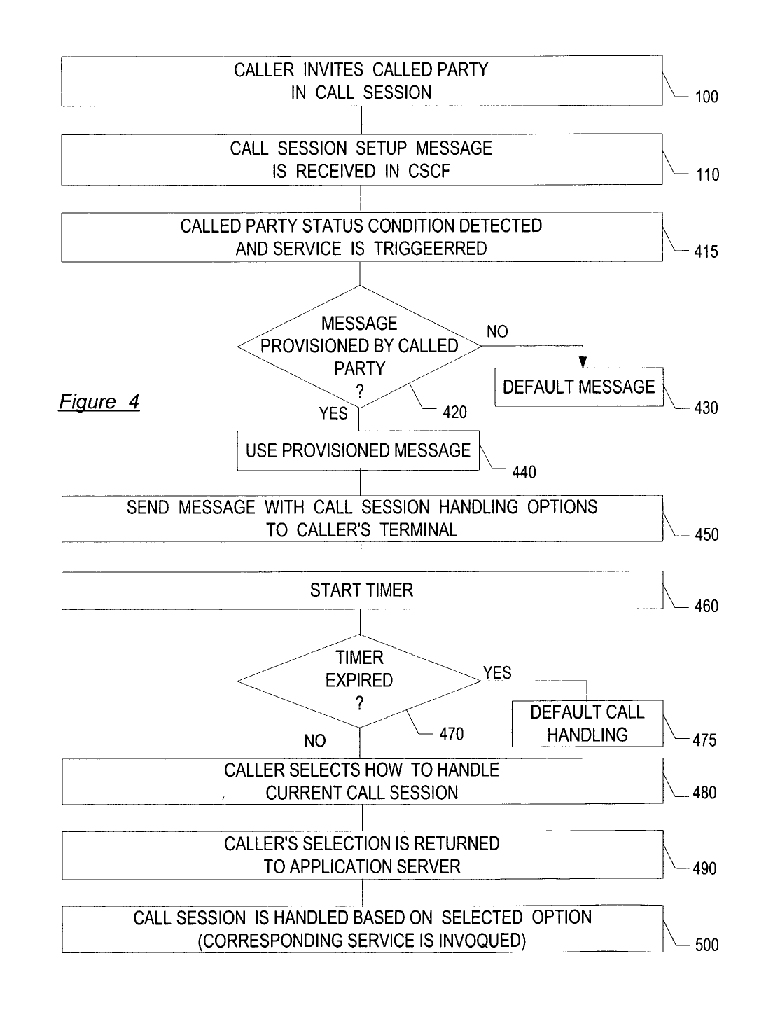

Referring now to FIG. 4, depicted therein is an exemplary flowchart diagram of a mechanism for providing services in the context of a setup of a call session according to another preferred embodiment of the invention. At step 100, the caller invites the called party into a communications session, such as for example into a Session Initiation Protocol (SIP) based communications session by issuing a communication set-up message, such as for example an SIP INVITE message comprising an identification of the called party. The requested call session may be of any type, such as for example a video call session, a voice call session, a file transfer call session, or a message call session. At step 110, the communication setup message reaches a serving Call Session Control Function (CSCF) of the called party.

In step 415, it is detected a trigger condition for activating the providing of services to the called party to have the caller determine further treatment of the call, which in the present embodiment relates to interactive call session redirection service. The trigger condition detected in step 415 may comprise detecting a certain busy or other called party status, either directly provided by the network in the context of call setup, or as pre-defined by the called party subscriber. In particular, the trigger condition may comprise a busy condition, an unavailable condition, and a call forwarding activated condition. According to a variant of the preferred embodiment of the invention, for the performance of step 415, an application server linked to the called party's serving CSCF may receive the call session set-up message from the CSCF, and may query a presence server for information regarding the called party subscriber's presence status. When a given presence status associated with the called party is detected, the condition for activating the call session redirection service is considered to be met. In step 420, the method detects whether or not the called party has provisioned the system, i.e., for example, the application server, with a message to be used by the call session redirection service. In the negative, the method selects a default message, step 430. Otherwise, if the called party has provisioned its message, the method decides in step 440 to use the subscriber-provisioned message. In both situations, at step 450 the selected message is sent to the caller with information regarding the status of the called party subscriber. For example, a default message may state:

“Subscriber Bob is BUSY.

Leave of voicemail message or a video mail message or drop the call.”

wherein the underlined characters represent HTTP URI associated with a given service in the application server.

In the opposite case, wherein the called party has provisioned a message for use with the call session redirection service and comprising the options to be presented to a caller when a given condition is met, the message sent to the caller including the called party's message, step 450, may be, for example:

“Subscriber Bob is busy.

Drop call session

Or

Contact

John for project A;

Mary for project B;

My Admin for any other issues,”

wherein the underlined characters represent HTTP URIs associated with a given service.

In both cases, the message preferably comprises an option directed to forwarding the current call session to a third party that may comprise a third party user terminal, a default location like the voice mail system, or any other call session terminating party.

Following step 450, when the message is sent towards the caller's terminal, a timer is started in step 460 for defining and monitoring a time period during which the caller is allowed to reply to the message. If the time period defined by the timer has not expired, as detected in step 470, then in step 480 the caller provided with the message selects one of the available services submitted with the message, which regard the manner in which the current call session is to be handled from this point forward. At step 490, the caller's selection is returned to the application server and at step 500 the call session is handled according to the caller's selection.

For example, if the caller has chosen to contact “Mary” to speak about “project B”, by clicking on the 2^{nd} service, the call session is redirected to Mary's terminal using on Mary's terminal address provided by the called party user during the predefinition of the call session redirection service (not shown). If the timer expires at step 470 without any input being received from the caller, the call session is handled according to a default scenario, step 475. For example, the call session can be simply dropped in such a case.

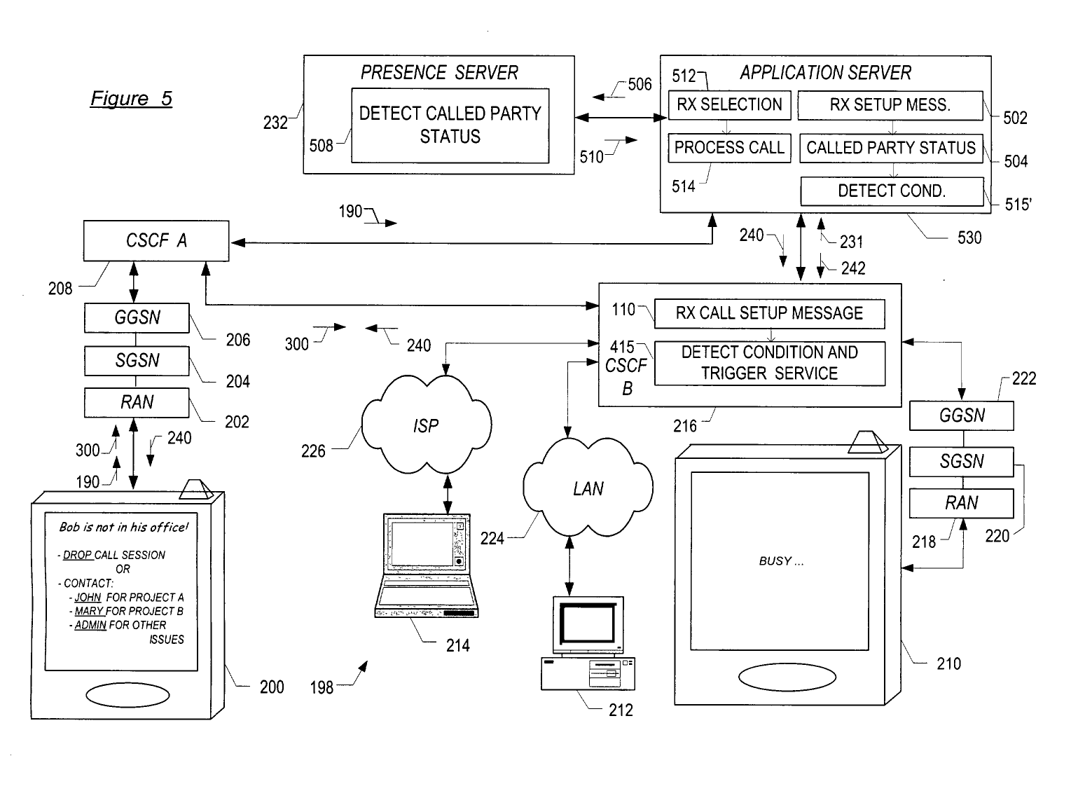

Reference is now made to FIG. 5, which is an exemplary network and signal flow diagram in which the present invention is implemented, in accordance with another one of the preferred embodiments of the invention. It is to be noted that although the exemplary preferred embodiment of the present invention shown in FIG. 5 is described in relation to a cellular telecommunication network, the invented mechanism for providing services, which in the present embodiment relates to an interactive inbound session handling, is applicable to any kind of Internet Protocol (IP) based network. For the purpose of the present exemplary scenario, it is assumed that caller Alice (A) uses the terminal A 200 in order to establish a new communication session, such as for example a video communication session with user Bob. To do so, user Alice uses terminal 200 to issue the communication set-up message 300, such as for example the SIP INVITE message, intended for user Bob. The message 300 is sent from the terminal A 200 via the RAN 202, the SGSN 204 and the GGSN 206 to the serving CSCF A 208, from where it is forwarded to the serving CSCF B 216 of user Bob.

Upon receipt of the communication set-up message 300, action 110, the CSCF B 216 detects a trigger condition for activating the providing of services, which in the present embodiment is the interactive inbound session handling service, action 415. For this purpose, according to a first variant of the invention, the CSCF B 216 may detect itself a given condition associated with a subscriber Bob, such as for example a busy status of its terminal, an unavailable status of its terminal, or any other condition pre-provisioned by user Bob to the system for activating the call session redirection service. Alternatively, according to a second variant of the present invention, in order to detect the condition for triggering the call session redirection service, upon receipt of the call setup message at step 110, the CSCF B 216 signals in action 231 the application server 230 connected thereto, for inquiring of presence status related to the called party Bob. The application server 230 receives the call session setup message 300 with the called party's identification that may be comprised into a signaling 231, action 502, and in action 504 determines the called party's status by, in turn, signaling the presence server 232 connected therewith for requesting presence status information related to the called party, action 506. Based on the same identification of the called party from message 300, the presence server 232 detects the actual presence status of the called party, action 508, and returns back to the application server 230 in action 510 the presence status associated with the called party. According to the second variant of the preferred embodiment of the invention it is based on this information received from the presence server 232 that the application server 230 detects the condition for triggering the call session redirection service of the present invention, action 515′.

Following either action 415 or 515′, the application server 230 initiates the interactive call session redirection service and sends to the caller's terminal 200 a message 240, action 450 (shown in FIG. 4), as described hereinbefore with reference to FIG. 4, in order to inquire how to handle the call session that is in course of establishment, since the called party Bob was detected, for example, as being in a position where he cannot answer the call session from any of his terminal(s). Message 240 is preferably pre-provisioned by the called party with the application server 230, and typically comprises a series of options for handling the call session. Upon receipt of message 240, the caller's terminal 200 displays the message for the caller.

Following receipt of the message 240, the caller may select the desired service for handling the call, such as for example to be redirected to Mary's terminal, action 480 of FIG. 4. The caller's selection is returned to the application server 230 via the packet data network to the application server 230, action 490, and the application server 230 receives the selection, action 512. Finally, in action 514, the application server 230 processes the call session based on the selected service, such as for example by instructing the serving CSCF B 216 to redirect the call session to subscriber “Mary” as chosen by the caller. This action may be done by having the application server 230 send to the CSCF B 216 the address of user “Mary”, which was pre-provisioned by the called party user to the application server 230 before the current call session, during the pre-definition phase of the call session redirection service.

In the preferred implementation of the invention, the interrogation message 506 is a standardized Subscribe message, and the response message 510 is an SIP Notify message, as defined, for example, in the Internet Engineering Task Force's (IETF) SIP for Instant Messaging and Presence Leveraging Extensions (SIMPLE) standard, herein included by reference.

Even though the present invention has been described in the context of evolved terminals (laptop, cell phones, etc.) and the networks they use, it should be understood that the present invention could also be interfaced to less evolved terminals (fixed phone for example). For doing so, well-known gateways can be used as an interface between such less evolved terminals and the more conventional networks (such as the Public Switched Telephone Network, or Public Land Mobile Networks of first and second generations) they use, for providing the service of the present invention. In such instances, the previously described SIP URI could be replaced by a TEL URI which would redirect all signalling to the gateway, so that the gateway can interface the two networks.

Based upon the foregoing, it should now be apparent to those of ordinary skill in the art that the present invention provides an advantageous solution, which offers efficient providing of services to terminal users. The present invention is understood to be practiced in connection with any kind of communications protocol and in any kind of IP-based communications network, including in any kind of such cellular of fixed telephone network. Preferably, the invention may be performed using SIP based signaling such as described in the IETF's Request For Comments (RFC) 2543, herein included by reference. Also, as mentioned, the network 198 may comprise any kind of telecommunications network, such as for example but not limited to a Third Generation telecommunications network such as a GPRS cellular network, a CDMA 2000 cellular network, a Wide CDMA cellular network, an GSM-based EDGE cellular network, any kind of IP-based communications network, or any variant thereof. Preferably, the network 198 will support SIP-based communications. The operation of the presence server 232, and the storing of the presence information therein, may be performed according to the Third generation Partnership Project (3GPP) Release 6 specification, and/or in the IETF' SIMPLE specification, both of which are herein included by reference, although it is understood that other implementations are also possible. Finally, the instant message may take various forms, such as for example but not limited to an e-mail message, an SIP message, a Short Message Service (SMS) message, or a Multimedia Service (MMS) message.

It should be realized upon reference hereto that the innovative teachings contained herein are not necessarily limited thereto and may be implemented advantageously with any applicable radio telecommunications network or standard. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow.

What is claimed is:

1. A mechanism for providing services to a terminal user, the mechanism comprising:
identifying at least one service to be offered to the terminal user;
linking each of the identified at least service to a corresponding Hyper Text Terminal Protocol Uniform Resource Identifier (HTTP URI);
building a list of all linked HTTP URIs; and
forwarding the list of linked HTTP URIs to the terminal user.

2. The mechanism of claim 1, wherein the services are session-related.

3. The mechanism of claim 2, wherein the identifying is performed before call completion to the terminal.

4. The mechanism of claim 2, wherein the identifying is performed during a call.

5. The mechanism of claim 2, wherein the identifying is performed upon call termination.

6. The mechanism of claim 1, wherein the forwarding is performed using a Session Initiation Protocol (SIP) instant message.

7. The mechanism of claim 1, wherein the terminal consists of a plurality of terminals, each terminal having its own identification address, and the forwarding is performed to the plurality of terminals.

8. The mechanism of claim 7, wherein the plurality of terminals comprises a mobile station and a computer.

9. The mechanism of claim 1, wherein the mechanism further comprises displaying the list of linked HTTP URIs on the terminal.

10. The mechanism of claim 9, wherein the mechanism further comprises: selecting by the user one of the displayed HTTP URIs and forwarding the selected HTTP URI over a Packet Data Network.

11. The mechanism of claim 3, wherein the terminal user is a called terminal user.

12. The mechanism of claim 3, wherein the terminal user is a calling terminal user.

13. The mechanism of claim 4, wherein the terminal user is a called terminal user.

14. The mechanism of claim 4, wherein the terminal user is a calling terminal user.

15. The mechanism of claim 5, wherein the terminal user is a called terminal user.

16. The mechanism of claim 5, wherein the terminal user is a calling terminal user.

17. The mechanism of claim 1, wherein the services consist of a plurality of the following services: selective call forwarding, initiate call conference, engage call with third party, transfer to other terminal or selection of call type.

18. The mechanism of claim 1, wherein the identifying, the linking and the building is performed by an application server.

19. The mechanism of claim 1, wherein the HTTP URI address includes a prefix identifying an application providing the service.

20. A terminal for providing services to a user of the terminal, the terminal being capable of:
receiving an incoming message, the incoming message comprising at least one Hyper Text Terminal Protocol Uniform Resource Identifier (HTTP URI) corresponding to a service being offered to the user;
displaying the at least one HTTP URI to the user;
obtaining a selection from the user; and
activating the HTTP URI corresponding to the user's selection.

21. The terminal of claim 21, wherein the services are session-related.

22. The terminal of claim 22, wherein the receiving is performed before a call completion to the terminal.

23. The terminal of claim 22, wherein the receiving is performed during a call.

24. The terminal of claim 22, wherein the receiving is performed upon a call termination.

25. The terminal of claim 23, wherein the terminal user is a called terminal user.

26. The terminal of claim 23, wherein the terminal user is a calling terminal user.

27. The terminal of claim 24, wherein the terminal user is a called terminal user.

28. The terminal of claim 24, wherein the terminal user is a calling terminal user.

29. The terminal of claim 25, wherein the terminal user is a called terminal user.

30. The terminal of claim 25, wherein the terminal user is a calling terminal user.

31. The terminal of claim 21, wherein the services consist of some of the following services: selective call forwarding, initiate call conference, engage call with third party, transfer to other terminal or selection of call type.

32. The terminal of claim 31, wherein the HTTP URI address includes a prefix identifying an application providing the service.
